(19) United States
(12) Patent Application Publication
(10) Pub. No.: US 2010/0209176 A1
(43) Pub. Date: Aug. 19, 2010

(54) BINDER FITTING

(75) Inventor: Toshio Okamura, Hyogo (JP)

Correspondence Address: JORDAN AND HAMBURG LLP, 122 EAST 42ND STREET, SUITE 4000, NEW YORK, NY, 10168, US

(73) Assignee: Okamura Yugen Kaisha, Nishinomiya-shi (JP)

(21) Appl. No.: 12/450,718

(22) PCT Filed: Apr. 19, 2007
(86) PCT No.: PCT/JP2007/000425

§ 371 Date: Oct. 8, 2009

(51) Int. Cl. B42F 13/12

(52) U.S. Cl. 402/60

(57) ABSTRACT

A binder fitting 1 has a horizontal base plate 2; rod members 3 vertically fixed on the base plate 2; male screws 8 formed in portions of the peripheral surface of each rod member 3; a press member 4, which has guide holes where the rod members 3 are inserted to be slidable, respectively, and a press surface 10 that presses an object to be filed P, and which is vertically movable in parallel due to a guiding effect of the rod members 3 and the guide holes while angles formed with the press surface 10 and the rod members 3 are maintained at right angles, when pressing the object to be filed P; and operational nuts 5, which are screwed together with the screws 8 of the rod members 3, respectively, and which can press and drive the press member 4 toward the base plate 2.

### TECHNICAL FIELD

The present invention relates to a binder fitting in which an object to be filed is filed by pressing one end thereof, and particularly relates to a binder fitting that is capable of pressing strongly and easily by effectively using a screw mechanism.

### BACKGROUND TECHNOLOGY

A two-hole type binder fitting where two rods or two flexible band members are threaded through two holes formed at the end portion of an object to be filed, such as documents, and a press-type binder fitting that presses and clamps an object to be filed without making holes at the end portion of the object to be filed have been available as the binder fitting mounted to a binder. The present invention relates to a press-type (clamp-type) binder fitting.

In the case of the two-hole type binder fitting, it is bothersome to form a pair of holes at the left end portion of the object to be filed, and the object to be filed is damaged due to the holes, and, the insertion and/or removal of the object to be filed is also troublesome.

As the press-type binder fitting, a binder fitting composed with a base plate secured to a cover page, a retainer plate, a parallel link mechanism that connects the retainer plate to the base plate, a lever member, and a torsion spring connected to the parallel link mechanism and the lever member has been widely in practical use.

In this type of binder fitting, the object to be filed of a maximum of approximately 3 cm of thickness can be filed. However, in order to realize a binder fitting to file the object to be filed of greater thickness, it is necessary to enlarge the size of the parallel link mechanism, the lever member and the torsion spring, making it less practical, owing to such as higher production cost.

In the meantime, the applicant of the present application has proposed a binder fitting (a pressing device for filing) such as that shown in Patent Document 1. This binder fitting has a base plate, a press plate, a pair of trapezoidal-legged link members that connect the base plate to the retainer plate, a guide mechanism that guides the lower ends of the link members to be horizontally movable, a lockable ratchet mechanism to prevent the lower ends of those link members from relatively approaching, and a release mechanism that releases the ratchet mechanism.

In the binder fitting, since a pair of the link members have to be controlled so as not to incline from a vertical plane by the guide mechanism that guides the lower ends of a pair of the link members to be movable, the structure of the guide mechanism is complex, increasing production costs. In addition, since the number of components increase as a whole, a longer base plate and guide mechanism, and a pair of longer link members with great strength and high rigidity are required, enlarging the entire binder fitting, increasing production costs. In addition, when filing something thick, since a pair of the link members become close to right angles relative to the base plate, it is difficult to generate strong pressing force.

The binder fitting described in Patent Document 2 is composed with stretchable screw shafts (a lower-stage screw shaft, and an upper-stage screw shaft screwed together with the lower-stage screw shaft) vertically fixed to the base plate, a gear box screwed together with the upper end of these screw shafts, a worm wheel fixed to the upper end of the screw shafts, a worm gear meshed with the worm wheel and mounted to the gear box, and a handle for manually turning the worm gear.

The binder fitting described in Patent Document 3 is composed with a base plate, a screw shaft vertically fixed in this base plate, a horizontal adjustment plate where this screw shaft penetrates, a pair of plate springs that are secured to the adjustment plate at the both ends of the screw shaft, and whose upper end is locked by the screw shaft, a horizontal cam shaft supported by a bearing of the adjustment plate, an eccentric roller cam fixed to the end of the cam shaft, an operation lever fixed to a mid-part of the cam shaft, and an elliptical plate cam fixed to the proximate end of the cam shaft, that can open/close a pair of the plate springs.

The configuration is such that if the eccentric roller cam contacts the upper surface of the plate member situated on the upper surface of the object to be filed, and the eccentric roller cam is rotated by turning the cam shaft with the operation lever, the object to be filed can be strongly pressed due to the increase force effect of the eccentric roller cam.

### Patent Document 1: Japanese Laid-Open Patent Publication 2001-260582

### Patent Document 2: Japanese Laid-Open Patent Publication H1-210397

### Patent Document 3: Japanese Laid-Open Patent Publication H1-272493

### DISCLOSURE OF THE INVENTION

### Problems to be Solved by the Invention

With the binder fitting described in Patent Document 2, the gear box is moved vertically by turning the screw shaft via the worm gear mechanism or by manually turning the gear box, and the object to be filed is clamped by the gear box. Consequently, when inserting/removing the object to be filed, the screw shaft and the gear box cannot be rapidly turned, and it takes time to insert and/or remove the object to be filed.

It is an open question as to whether the gear box can be maintained in a horizontal posture relative to a torque that affects the gear box due to a reaction force from the object to be filed in the state where it is clamped. Since the binder fitting also contains many components including the screw shaft, the worm gear mechanism and the gear box, and the structure is complex, increasing production costs, making it impractical.

The binding fitting in Patent Document 3 presses the object to be filed not using a fastening power of the screw mechanism but using an increase force effect of the eccentric roller cam. There is no disclosure of a mechanism for maintaining the adjustment plate horizontal while the object to be filed is pressed. Since the binder fitting comprises many components and the structure is complex and the production cost also is high, it is impractical.

The reason a binder fitting where a screw mechanism is adopted scarcely comes into practical use is because it is assumed to be difficult to promptly turn nut members for pressing by hand; when a press member for pressing the object to be filed is moved vertically while being guided by a screw shaft, and since the press member interferes with a thread ridge of the screw shaft, it is difficult to smoothly move the press member vertically. If the object to be filed is pressed while a left end of the object comes into contact with two screw shafts, the left end of the object may be interlocked with the screw mechanism; and even if not interlocked, the left end of the object may be damaged.

### Means to Solve the Problem

A binder fitting of the present invention that presses one end portion of an object to be filed, such as documents, and binds it, the invention is characterized by comprising a base plate, which is horizontal in a posture when inserting and/or removing the object to be filed; a rod member vertically fixed on the base plate; male screws formed throughout an entire length of one or more parts of a peripheral surface of the rod member; a vertically-smooth receiving surface that is formed throughout an entire length of a side surface of the rod member and receive an end of the object to be filed; a press member, which has a guide hole where the rod member is inserted to be slidable and a press surface for pressing the object to be filed, and which is vertically movable relative to the rod member while an angle formed with the press surface and the rod member is maintained at a right angle due to a guiding effect of the rod member and guide hole when the object to be filed is pressed; and an operational nut screwed together with the male screws of the rod member at an upper side of the press member.

### ADVANTAGES OF THE INVENTION

According to the binder fitting in claim 1, since it is structured such that a press member is pressed to the clamp side by the male screws formed in the rod member and the operational nut screwed together with these male screws, a strong pressing force (clamp force) can be generated with this simple structure. An object to be filed can also be easily inserted and/or removed with a simple operation to turn the operational nut. Since flat and smooth receiving surface are formed on the rod member along the vertical direction, even if the press member is pressed and driven while the end of the object to be filed is received by the receiving surface, the end of the object to be filed will not be damaged.

When the object to be filed is pressed, since the press member is vertically movable in parallel relative to the rod member while the angles formed with the press surface and the rod member is maintained at a right angle, no impression will be formed upon the object to be filed, and the object to be filed can be easily and assuredly pressed. Since the rod member is also used as a member to receive the end of the object to be filed, the structure can be simplified.

### BRIEF EXPLANATION OF THE DRAWINGS

FIG. 1 is a front view of a binder fitting in Embodiment 1.

FIG. 2 is a right side view of the binder fitting shown in FIG. 1.

FIG. 3 is a left side view of the binder fitting shown in FIG. 1.

FIG. 4 is a plan view of the binder fitting shown in FIG. 1.

FIG. 5 is a base view of the binder fitting shown in FIG. 1.

FIG. 6 is an enlarged cross sectional view along the VI-VI line in FIG. 2.

FIG. 7 is an enlarged cross sectional view of a main section along the VII-VII line in FIG. 2.

FIG. 8 is a front view of the binder fitting (filed state) shown in FIG. 1.

FIG. 9 is a plan view of a binder fitting in Embodiment 2.

FIG. 10 is an enlarged cross sectional view of a main section in a modified example.

FIG. 11 is a view equivalent to FIG. 6 of a binder fitting in another modified example.

### DESCRIPTION OF NUMERALS

1, 1B, 1A binder fitting
2 base plate
3, 3B, 3C rod member
3a, 3b guide surface
4, 4A, 4C press member
4a main body plate
4b thick plate
5 operation nut member
6 screw hole
7 screw member
8, 8C male screw
9, 9C guide hole
10 press surface
11 screw member
P object to be filed

### BEST MODE FOR IMPLEMENTING THE INVENTION

This binder fitting enables easily strong and prompt press and release of an object to be filed, such as documents, by a screw mechanism, preventing interference with the object to be filed by the male screws of the screw mechanism.

### Embodiment 1

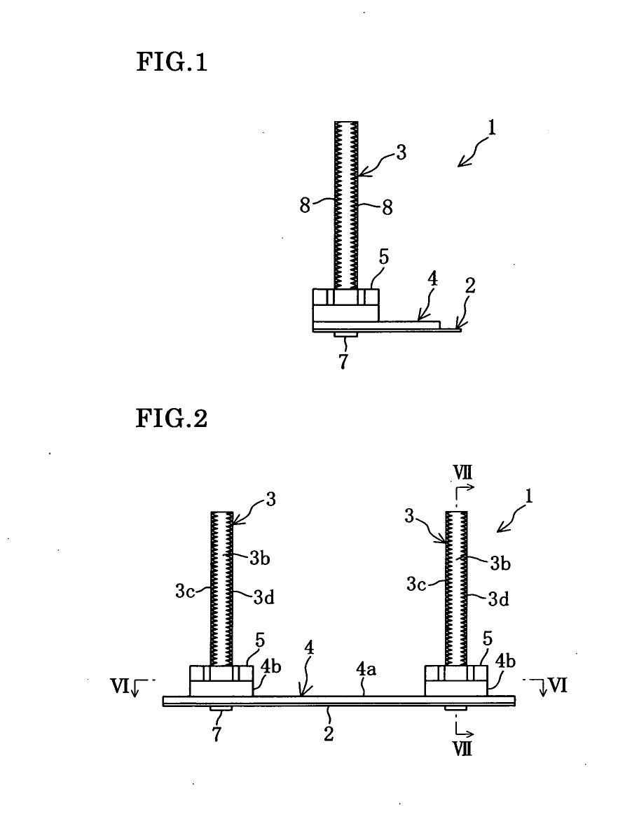

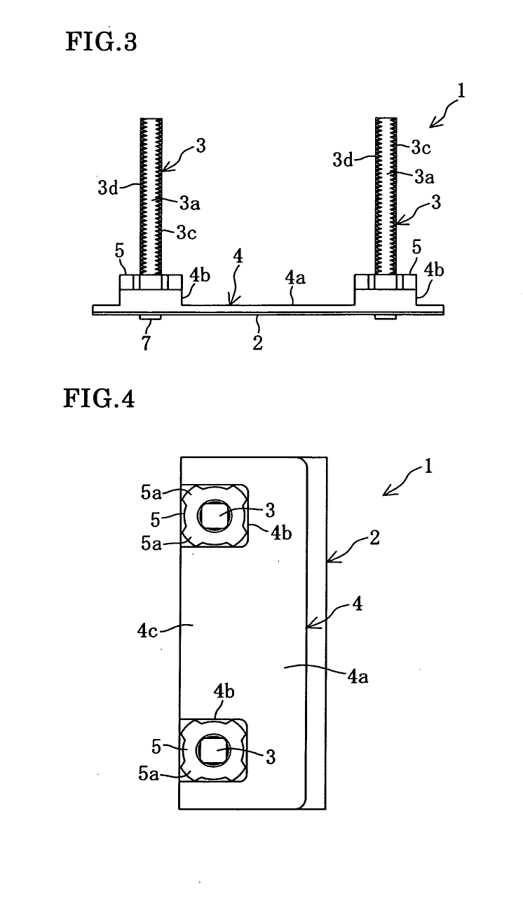

As shown in FIG. 1 to FIG. 5, although a binder fitting 1 is used by incorporating into a binder having a cover, this binder fitting 1 is solely usable. This binder fitting 1 files an object to be filed P (see FIG. 8) by pressing one end portion. The binder fitting 1 comprises a base plate 2, a pair of rod members 3 vertically fixed on the base plate 2, a press member 4 and a pair of operational nuts 5.

The base plate 2 is in a horizontal posture when inserting and/or removing the object to be filed P, and the horizontal posture of the base plate 2 (the state in FIG. 4) will be described as the basis for the front/rear direction, the left/right direction and the vertical direction hereafter. A pair of the rod members 3 are vertically fixed on the base plate 2. The press member 4 has a pair of guide holes 9 where a pair of the rod members 3 are inserted to be slidable, and a press surface 10 for pressing the object to be filed P. The press member 4 is vertically movable in parallel relative to the rod members 3 due to the guiding effect of the rod members 3 and the guide holes 9 while the angles formed with the press surface 10 and the rod members 3 are maintained to be at right angles when pressing the object to be filed P. The operational nuts 5 are screwed together with male screws 8 of the rod members 3 and can press and drive the press member 4 downward.

The base plate 2 is a rectangular metal plate member, which is a long strip in the direction along the left end portion of the object to be filed P, and for example, is made of a stainless steel plate or a plated steel plate. The size of the base plate 2, for example, is 35 mm×90 mm. A pair of the rod members 3 are fixed at predetermined intervals in the longitudinal direction of the base plate 2, and the rod members 3 (for example, 40 mm to 80 mm of length) are vertically fixed and secured to the base plate 2. These rod members 3 are formed, for example, with a steel material or a magnesium alloy. The rod members 3 may be entirely or partially formed with synthetic resin.

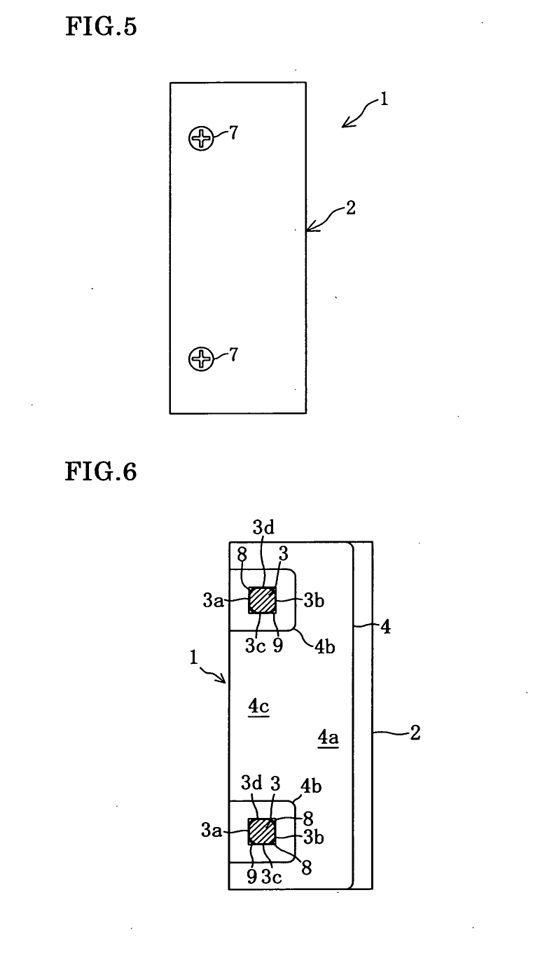

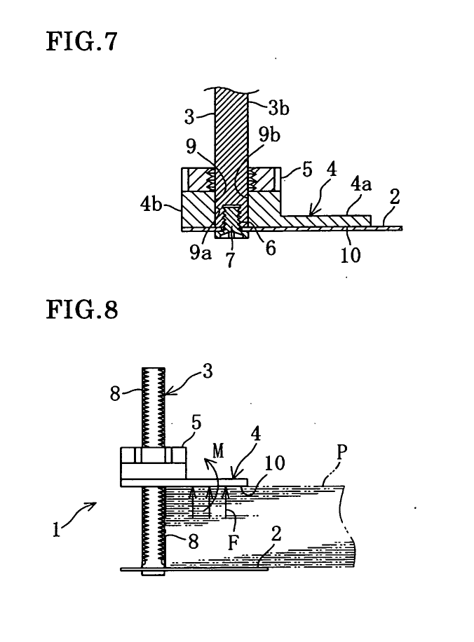

As shown in FIG. 5 and FIG. 7, in each rod member 3, corners of columns whose cross sections are square with a side approximately 6 mm to 8 mm long, respectively, are formed to be partially cylindrical, and the male screws 8 are formed at the corners. Vertical screw holes 6, which are opened from the lower end, are formed at the lower ends of the rod members 3, respectively, and the rod members 3 are secured to the base plate 2 to be detachable by screw members 7, which are inserted into circular holes of the base plate 2 from the lower side and are screwed together with the screw holes 6, respectively.

The horizontal cross section of each rod member 3 is formed to be square having rounded corners, and the male screws 8 are formed at the four corners throughout the entire length of the rod member 3, and the operational nuts 5 are screwed together with the four male screws 8 of the rod members 3 at the upper side of the press member 4. Guide surfaces 3a and 3b, which are flat and smooth at least along the vertical direction, are formed on the both right and left sides of the rod members 3 throughout the entire length of the rod member 3, respectively, and this guide surface 3b is equivalent to an ‘abutment’ that receives the left end of the object to be filed P. Guide surfaces 3c and 3d, which are flat and smooth at least along the vertical direction, are formed on the both front and rear sides of the rod members 3 throughout the entire length of the rod member 3, respectively. Since the flat guide surfaces 3a to 3d appear on the four surfaces of the rod members 3, this is preferable an aspect of design.

The press member 4 is formed, for example, with a steel material, a magnesium alloy or an aluminum alloy. The press member 4 may be entirely or partially formed with a synthetic resin material. The size of this press member 4 in a plane view is substantially the same as that of the base plate 2, for example, 30 mm×90 mm. The press member 4 is provided with a pair of the guide holes 9 where a pair of the rod members 3 are inserted to be slidable, respectively, and a press surface 10, which is a plane for pressing the object to be filed P, and which is formed on the lower surface of the press member 4.

The press member 4 is vertically movable in parallel due to the guiding effect of a pair of the rod members 3 and a pair of the guide holes 9 while the angle formed with the press surface 10 and the rod member 3 are maintained to be at a right angle, when the object to be filed P is pressed. This is also similar to when the press of the object to be filed P is released.

The press member 4 has a plate-like main body plate 4a (for example, approximately 1.0 mm to 2.0 mm of thickness), and a pair of thick plates 4b, which are integrally formed with the main body plate 4a and substantially square in a planar view, and which correspond to a pair of the rod members 3, respectively. The size of each thick plate 4b, for example, is 17 mm×17 mm, and the thickness of the thick plate 4b is twice to three times as that of the main body plate 4a. The guide hole 9, which vertically penetrates, and whose horizontal cross section is substantially square, is formed in each thick plate 4b, and these thick plates 4b are pressed by the operational nuts 5 from the above, respectively.

If the object to be filed P is pressed by the press member 4 and becomes in the clamp state, as shown in FIG. 8, because a reaction force F from the object to be filed P is applied and a torque M against the object to be filed P is applied to the press member 4, as shown in FIG. 7, controllers 9a and 9b, which maintain the angles formed with the press surface 10 of the press member 4 and the rod members 3 at right angles in the state where the object to be filed P is pressed, and which have predetermined vertical width, are formed on the inner wall surface of the guide holes 9, respectively.

Small slide gaps (for example, 0.1 mm to 0.2 mm of gaps) are formed between the right and left guide surfaces 3a and 3b of the rod members 3 and the right and left inner wall surfaces of the guide holes 9, respectively, and the left-side inner wall surface and the right-side inner wall surface among the inner wall surfaces of each guide hole 9 form the controllers 9a and 9b. In the meantime, slide gaps, which are larger to some extent than the smaller slide gaps described above, are formed between the guide surfaces 3c and 3d in front and behind the rod members 3 and the front and rear the inner wall surfaces of the guide holes 9, respectively, in order to smoothly move the press member 4 vertically even if the press member 4 is slightly inclined toward the front or rear side, when the press member 4 is moved vertically.

As shown in FIG. 6, since the male screws 8 face against the corner spaces of the guide hole 9 within each guide hole 9, when the press member 4 is moved vertically relative to the rod members 3, the male screws 8 of the rod members 3 will never interfere with the press member 4; therefore, the press member 4 can be smoothly moved vertically.

As shown in FIG. 1 to FIG. 3, the operational nuts 5 are screwed together with the male screws of the rod members 3 at the upper side of the press member 4, respectively, and manual turning operation of these operational nuts 5 enables strong press and drive of the press member 4 toward the base plate 2. This operation nut member 5 is formed, for example, with a steel material, brass, a magnesium alloy, an aluminum alloy or a synthetic resin.

As shown in FIG. 4, each operation nut member 5 has four protruding operation parts 5a, and turning of the operation parts 5a by fingers in the state where the operation nut member 5 is screwed together with the rod member 3 enables tightening of the operation nut member 5. Since the male screws of each rod member 3 are formed from the four male screws 8 at the corners of the rod member 3, a friction force to be applied between the male screws 8 and the operation nut member 5 becomes smaller. Therefore, when no press load is asserted, the operation nut member 5 can be smoothly and rapidly turned. It is desirable that the operation nut member 5 is formed with the size, which can fit within the range of the thick plate 4b of the press member 4 as shown in FIG. 4, from the viewpoint of design. The operation part 5a can project outward the thick plate 4b.

Because the male screws of each rod member 3 are formed at the four corners, the contact area where the operation nut member 5 makes contact with the male screws 8 becomes smaller; thus, it is desirable to increase the thickness of the operation nut member 5 and to increase the number of thread ridges to be engaged with the male screws 8. Furthermore, the shape of each thick plate 4b and the shape of each operation nut member 5 are appropriately modifiable. The four male screws 8 of the rod members 3 and the operational nuts 5 comprise a screw mechanism to drive the press member 4 toward the clamp side.

Operation and advantages of the binder fitting 1 described above shall be described.

When the object to be filed P is mounted, the left end portion of the object to be filed P is mounted between the base plate 2 and the press member 4, and after the left end portion of the object to be filed P is positioned by coming into contact with the guide surfaces 3b (abutments) of a pair of the rod members 3, while the press member 4 comes into contact with the upper surface of the object to be filed P, if the operational nuts 5 are turned toward the tightening direction by hand, the press member 4 is moved in parallel downward while the angles formed with the rod members 3 and the press surface 10 are maintained at right angles, and the object to be filed P can be promptly and strongly clamped.

When the object to be filed P is removed, if the operational nuts 5 are slightly loosened, the press member 4 is moved in parallel upward while the angles formed with the rod members 3 and the press surface 10 are maintained at right angles, and the object to be filed P can be easily and promptly removed. Since it is configured that the press member 4 can be moved vertically in parallel relative to the rod members 3 and the angles formed with the press surface 10 of the press member 4 and the rod members 3 can be maintained at right angles, no press mark remains in the object to be filed P, and the object to be filed P can be strongly and efficiently clamped. This binder fitting 1 can be produced with less number of components, with a simple structure and at low cost.

Since the horizontal cross section of each rod member 3 is square having rounded corners, the turning of the press member 4 in the horizontal direction can be regulated by the rod members 3, and since the male screws 8 are formed at the four corners of each rod member 3, the frictional drag to affect the operational nuts 5 from the male screws 8 becomes lessened and the operational nuts 5 can be smoothly turned.

The right side of each rod member 3 is formed as the vertically-smooth guide surface 3b, and while the left end of the object to be filed P is received by these guide surfaces 3b, when the object to be filed P is pressed, even if the left end of the object to be filed P is moved relatively downward the guide surfaces 3b, because the guide surfaces 3b are vertically smooth planes, they will never damage the left end of the object to be filed P. In addition, the rod members 3 also function as the members to receive the left end of the object to be filed P, the number of components can be reduced and the structure can be simplified.

The guide holes 9 are formed in the thick plates 4b of the press member 4, and the controllers 9a and 9b are formed on the inner wall surface of the guide hole 9, respectively. The press member 4 can be moved in parallel vertically due to the guiding effect of these controllers 9a and 9b and the guide surfaces 3a and 3b of the rod members 3 while the angles formed with the press surface 10 of the press member 4 and the rod members 3 are maintained at right angles, even when the object to be filed P is pressed and even when the press is released.

Since the horizontal cross section of the guide hole 9 is formed to be square and the male screws 8 are orientated toward the spaces of the corners, the male screws 8 of the rod members 3 will never interfere in the press member 4 and the press member 4 can be smoothly moved vertically. The left end of the press member 4 projects from the left end of the object to be filed P toward the left side between the rod members 3, and the gripper 4c that is appropriate for moving the press member 4 vertically is formed. However, the gripper 4c may be omitted.

In the binder fitting 1, since it is structured such that the press member 4 is clamped and driven toward the base plate 2 by the screw mechanism composed of the operational nuts 5 and the male screws 8 of the rod members 3, a sufficiently strong clamp force can be generated by the screw mechanism, making it a binder fitting suitable for filing a thick object to be filed P. In addition, the operation when inserting and/or removing the object to be filed P is also easy, and the operation can be promptly completed.

### Embodiment 2

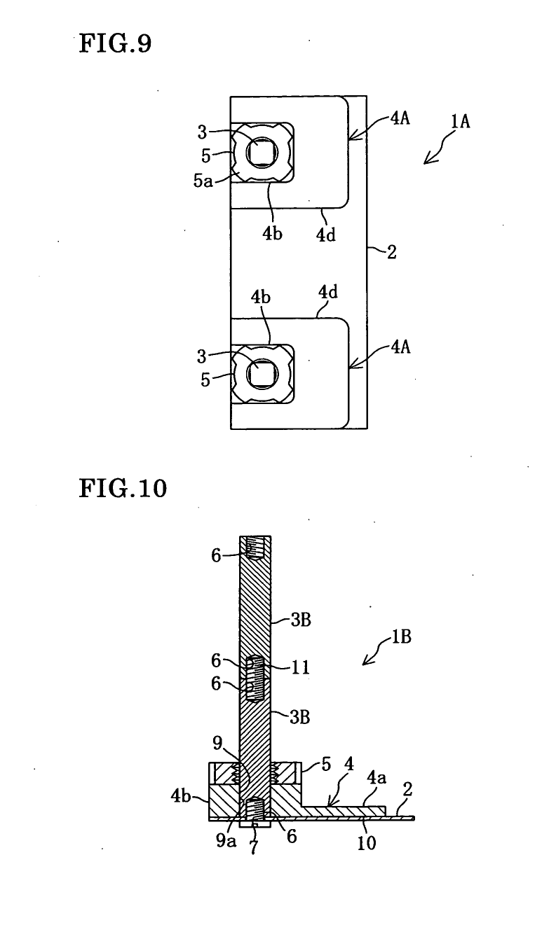

As shown in FIG. 9, in this binder fitting 1A, a pair of press members 4A corresponding to a pair of rod members 3 are arranged as press members. Since the other configurations are similar to those of Embodiment 1, only different configurations will be described. The press members 4A are formed, for example, to be substantially square in a plane view, and the press members 4A have a main body plate 4d and a thick plate 4b, respectively. The size of each press member 4A is, for example, 30 mm×30 mm, and the size of the thick plate 4b is, for example, 17 mm×17 mm. A guide hole, which is similar to the guide hole 9 mentioned above, is formed in each press member 4A.

Since this press member 4A is small-sized and can be easily moved vertically solely, the slide gaps between the front and rear guide surfaces 3c and 3d of the rod members 3 and the inner wall surface of the guide guide hole 9 may be narrower than the corresponding slide gaps in Embodiment 1. Since a pair of the press members 4A can be entirely small-sized and lightweight, this is advantageous from a viewpoint of the reduction of production costs. Since each press member 4A is small-sized, the clamp pressure to press the object to be filed P can be increased. Other than that, the similar actions and advantages to the binder fitting 1 can be obtained. Furthermore, the press members 4A will never rotate along the horizontal direction.

An example where above described embodiment is partially modified is described next.

[1] In order to increase the frictional force between the press surface(s) 10 of the press member(s) 4 or 4A and the object to be filed P, the press surface(s) 10 may be formed to be a friction surface, and a rubber coating layer may formed on the press surface(s) 10.
[2] The binder fitting may be composed with one base plate 2, one rod member, one press member and one operation nut member. Further, it may be composed with one base plate, three or more rod members, three or more press members and three or more operation but members.
[3] In a binder fitting 1B shown in FIG. 10, one divided rod member 3B is configured to be connectable on the upper end of another rod member 3B. A release screw hole 6 is formed at the upper end of the rod member 3B as similar to the screw hole 6 in the lower end, and the rod member 3B at the upper side has the same structure as the rod member 3B at the lower side. The upper and lower rod members 3B and 3B are fixed in series via a screw member 11 screwed together with the screw hole 6 at the upper side of the rod member 3B at the lower side and the screw hole 6 at the lower side of the rod member 3B at the upper side.

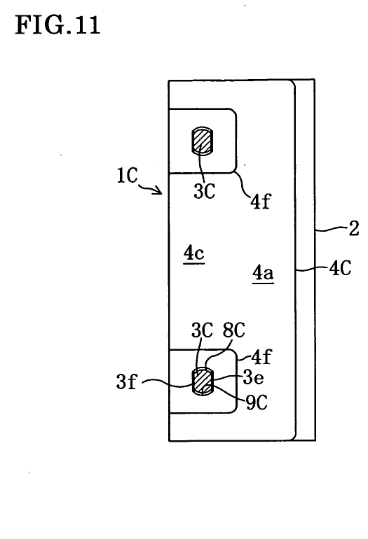

When the thickness of the object to be filed P is thin, the rod member 3B at the upper side is used without connecting with each other, and when the thickness of the object to be filed P becomes thicker, the upper and lower rod members 3B and 3B are connected and used. Furthermore, a negative groove or a positive groove for engaging a driver is formed at both of the upper and lower ends of the screw member 11. Furthermore, three or more rod members 3B can be connected in series.

[4] The shape of the horizontal cross section of each rod member is not limited to the one in the embodiments.
For example, as shown in FIG. 11, a pair of the rod members 3C are vertically fixed on the base plate 2, and a press member 4C is mounted over that. Vertically-smooth guide surfaces 3e and 3f are formed throughout the entire length of right and left sides of the rod members 3C, respectively, and partially-cylindrical male screws 8C are formed throughout the entire length of the front and rear sides of the rod members 3C, respectively.

A guide hole 9C where each rod member 3C is inserted to be slidable is formed in a press member 4C, and minute gaps similar to those in Embodiment 1 are formed between the guide surfaces 3e and 3f and the inner wall surface of the guide hole 9C, and the press member 4C is vertically movable in parallel relative to the rod members 3C while the angles formed with the rod members 3C and the press member 4C are maintained at right angles. The operational nuts (not shown) are screwed together with male screws 8C in front of and behind the rod members 3C.

[5] Other than those, a person with ordinary skills in the art pertaining to the present invention can add various modifications and can implement the present invention without departing from the concept of the binder fitting of the present invention, for example, the press member can be produced from a metal plate by press-molding, and the present invention shall include these modifications.

### INDUSTRIAL APPLICABILITY

This binder fitting is for binding an object to be filed by strong clamping without forming multiple punched holes in the object to be filed, and documents, drawings, pamphlets and any other various papers and sheets are can be easily filed and inserted and/or removed.

What is claimed is:

1. A binder fitting that presses one end portion of an object to be filed, such as documents, and binds the object, comprising:
a base plate, which is horizontal in a posture when inserting and/or removing the object to be filed,
a rod member vertically fixed on the base plate,
male screws formed throughout an entire length of one or more parts of a peripheral surface of the rod member,
a vertically-smooth receiving surface that is formed throughout an entire length of a side surface of the rod member and receive an end of the object to be filed,
a press member, which has a guide hole where the rod member is inserted to be slidable and a press surface for pressing the object to be filed, and which is vertically movable relative to the rod member while an angle formed with the press surface and the rod member is maintained at a right angle due to a guiding effect of the rod member and guide hole when the object to be filed is pressed, and
an operational nut screwed together with the male screws of the rod member at an upper side of the press member.

2. The binder fitting according to claim 1, wherein a horizontal cross section of the rod member is formed to be square with rounded corners, and the male screws are formed at four corners of the rod member, respectively.

3. The binder fitting according to claim 2, wherein a horizontal cross section of the guide hole is formed to be substantially square so as not to interfere in the male screws of the rod member and the press member.

4. The binder fitting according to claim 1, wherein multiple rod members arranged at predetermined intervals are provided as the rod member, and multiple guide holes where the multiple rod members are inserted are formed in one press member.

5. The binder fitting according to claim 1, wherein multiple rod members arranged at predetermined intervals are provided as rod members, and multiple press members corresponding to the multiple rod members are provided as the press member.

6. The binder fitting according to claim 1, wherein the press member includes a plate-like main body plate, and a thick plate, which is integrally formed with the main body plate, and where the guide hole is formed, and which is pressed by the operation nut member.

7. The binder fitting according to claim 1, wherein a vertical screw hole opened toward a lower end is formed at a lower end portion of the rod member, and the rod member is secured to the base plate to be removable by a screw member, which is inserted into a circular hole of the base plate from a lower side and screwed together with the screw hole.

8. The binder fitting according to claim 7, wherein a vertical screw hole opened toward an upper end is formed at an upper end portion of the rod member, and another rod member is configured to be connectable with the rod member in series via the screw member screwed together with the screw hole.
